(19) United States
(12) Patent Application Publication
(10) Pub. No.: US 2024/0305456 A1
(43) Pub. Date: Sep. 12, 2024

(54) DATA TAGS GENERATIONS IN NETWORK ENVIRONMENTS

(71) Applicant: Hewlett-Packard Development Company, L.P., Spring, TX (US)

(72) Inventors: Daniel Cameron Ellam, Bristol (GB); Adrian John Baldwin, Bristol (GB); Nelson L Chang, Palo Alto, CA (US); Stuart Lees, Bristol (GB)

(73) Assignee: Hewlett-Packard Development Company, L.P., Spring, TX (US)

(21) Appl. No.: 18/179,229

(22) Filed: Mar. 6, 2023

(51) Int. Cl. H04L 9/08; H04L 9/30

(52) U.S. Cl. CPC H04L 9/088; H04L 9/0822; H04L 9/3073

(57) ABSTRACT

A computing device may receive data associated with an event from an originating apparatus in the form of a data item. The computing device may then apply an evaluation function to the data item, wherein applying the evaluation function generates a processing result characterizing an aspect of the data item. The computing device may generate a tag based on the processing result. The computing device may associate the generated tag with the data, wherein the tag is transmitted with the data outside the network environment where the data item is not accessible for processing outside the network environment, but the data tag is accessible. The computing device may provide the data and the tag for transmission.

### BACKGROUND

Computer systems routinely exchange data between trusted networks and outside networks as part of various applications. In some implementations, a computing system within a trusted network obfuscates data before transmitting the data outside the trusted network, removing the ability to access any information about the original data. For example, a device within a trusted network may accept information and then obfuscate the information for transmission to a receiving device logically situated outside the trusted network. The obfuscation may remove the ability for the receiving device to retrieve any information about the originally accepted information.

### BRIEF DESCRIPTION OF THE DRAWINGS

Examples of various features of the present disclosure is now described with reference to the following drawings. Throughout the drawings, reference numbers may be re-used to indicate correspondence between referenced elements. The drawings are provided to show examples described herein and are not intended to limit the scope of the disclosure.

FIG. 1A is a diagram of example data flows and interactions between components in a first, or “trusted”, network with components in a second network.

FIG. 1B is a diagram of example data flows within a tagging module of the first network.

FIG. 2A is a block diagram of an example computing system to generate a data tag for a data item in a networked environment.

FIG. 2B is a block diagram of an example computing system to generate a data tag for a data item and obfuscate the data item in a networked environment.

FIG. 3 is a flow diagram of an example routine for generating a data tag for a data item and obfuscating the data item before transmitting the data tag and data item outside the first network environment.

FIG. 4 is a block flow diagram of an example process for generating a data tag for a data item in a networked environment.

### DETAILED DESCRIPTION

The present disclosure relates to the generation of data tags for data items in a networked environment, the data tags containing information about data items which may be lost when the data items are obfuscated prior to transmission outside of the networked environment.

Some systems have allowed for the obfuscation of data within a network, prior to the data being transmitted outside of the network (e.g., a login service which allows the user to enter login information in plain text on their device, and then transmits an encrypted version of the login information to the login service for authentication). When obfuscating data, important or useful information may be lost or concealed. For example, a hash applied to a username entered by a user into a login system may generate a fixed length output independent of the length of the input, and information related to the length of the user's input is lost during the obfuscation process and may or may not be recoverable. Even in the case where information about the data item may be recoverable, such information about the data item may still be hidden from a system where processing of the data item could be improved if the information was available.

In one example, a company may have a username structure of first initial of the user's first name followed by the first four letters of the user's last name (e.g., jjame), but when put through a cryptographic hash to maintain data security, the output for any username input results in a fixed length output (e.g., 01e12a14f289) determined by applying the hash to the input username. A fraudulent user attempting to breach the login system may then enter usernames that deviate from the standard format (e.g., jonahjameson) and that attempt would still result in an output from the hash of the same length as a valid username. The login system, only receiving the output hash values of a login attempt as login attempt information, would then only recognize that the login attempt was invalid after a comparison to a database of hashed username values, but could not recognize the difference between mistakes (e.g., typos of a valid user entering a valid username) and malicious login attempts as the underlying structure of the input username is lost during obfuscation. In this example, the login system compares the hashed username value to the database of hashed username values, requiring at least one database query.

However, in accordance with the present disclosure, continuing with the prior example, representing the structure of the username in, for example, a data tag appended to the output hash values of a login attempt allows for the login system to recognize that a nonconforming username could not be in the database of hashed username values and reject the login attempt without the login system being required to make a database query. Database queries generally require significantly more computing resources than, in this example, the login system processing a data tag to identify a true or false format conforming requirement for a username. Additionally, the ability to recognize malicious login attempts may allow the login system to prevent subsequent login attempts from an originating device, preventing a malicious user from guessing a correct username. Therefore, the addition of the data tag associated with a data item reduces the computing resources required by the login system to manage false login attempts and improves the security of the login system, while maintaining the privacy and security of the login attempt information.

The present disclosure is described with regard to certain examples, which are intended to illustrate but not limit the disclosure. Although aspects of some examples described in the disclosure focus on particular examples of input information, obfuscation methods, evaluation functions, association of a data tag with data, and the like, the examples are not intended to be limiting. In some examples, the techniques described herein may be applied to additional or alternative types of input information, obfuscation methods, and the like. Additionally, any feature used in any example described herein may be used in any combination with any other feature or in any other example, without limitation.

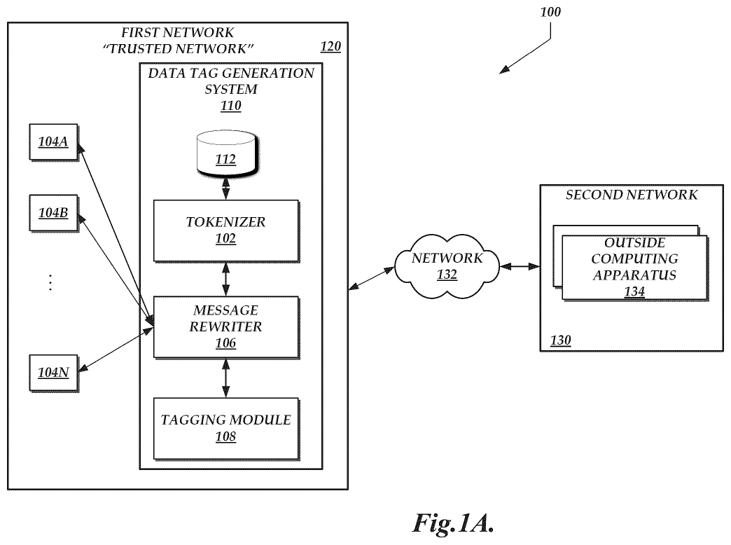

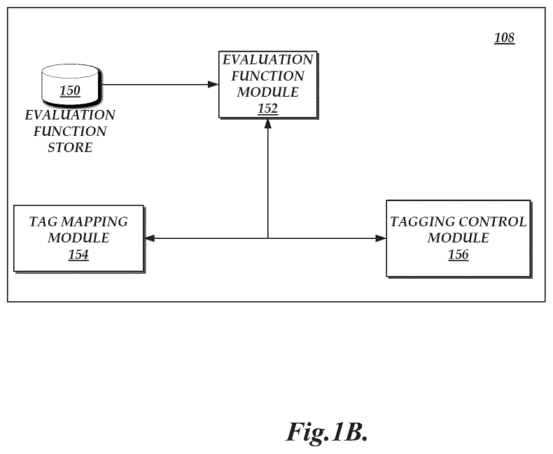

FIG. 1A shows an example data flow and interaction between components of a data tag system 100, including a data tag generation system 110 within a first network 120, which is a “trusted” network, and communication between the first network and a second network 130. The data tag generation system 110 is a system to accept input data from an originating apparatus 104A and apply an evaluation function to the input data to create a data tag representing an aspect of the input information that would otherwise be lost during an obfuscation process applied to the input data. As used herein, the second network 130 may refer to any component or set of components receiving data from the first network 120, where in the interest of security or privacy some or all of the input information is obfuscated such that a component of the second network 130 may not access the original version of the obfuscated information.

For example, an originating apparatus 104A used to log in to a login system may initially transmit, to the data tag generation system 110, a username, password, and IP address associated with the login attempt. To maintain user privacy and security of the login system, the username and password may be obfuscated, and the IP address removed entirely before transmitting the modified information to the login system over a network such as network 132. This blocks the interception of the original login data as the modified information is transmitted outside the first network 120, but also deprives the login system of the ability to quickly filter login attempts that do not conform to an expected format (e.g., a five character username, or an IP address within the domain of the first network 120) as the information necessary to do so is obfuscated or lost before the information is transmitted outside the first network 120. By transmitting the login information through the data tag generation system 110, a data tag may be applied to the modified data indicating, for example, the length of the input username and whether the IP address of the originating apparatus 104A was within the first network 120. Further, the data tag maintains this information without compromising the privacy or security of the user of the originating apparatus 104A by disclosing the original login data. The login system can then be informed when nonconforming login information is received by reading the data tag, and determine based on the data tag whether to process the login attempt.

The data tag generation system 110 includes a message rewriter 106, which manages the transmission of input data between various components of the data tag generation system 110. The data tag generation system 110 also includes a tokenizer 102, which may be in communication with an obfuscation information store 112, and which performs the action of converting the input data into an obfuscated format wherein some or all of the input data may no longer be accessible outside the first network 120. The obfuscation information store 112 is a system, such as a database, where different types of obfuscation data (e.g., private key data, hashing functions, etc.) may be stored. The tokenizer 102 and the obfuscation information store 112 may alternatively be incorporated into the message rewriter 106.

The data tag generation system 110 further includes a tagging module 108. The tagging module 108 evaluates the input data received from the message rewriter 106 by applying an evaluation function to the input data to generate a result used in a data tag. The tagging module 108 then creates the data tag based on the result of the evaluation function and associates the data tag with the input information at which point the input information and associated data tag are transmitted back to the message rewriter 106 for further processing, such as transmission to the tokenizer 102 for obfuscation.

In some examples, the tagging module 108 may be implemented using any set of a variety of computing devices, such as server computing devices, desktop computing devices, personal computing devices, mobile computing devices, mainframe computing devices, midrange computing devices, host computing devices, or some combination thereof.

In some examples, the features and services provided by the tagging module 108 may be implemented as web services consumable via a communication network. In further examples, the tagging module 108 is provided by a virtual machine implemented in a hosted computing environment. The hosted computing environment may include a rapidly provisioned and released computing resource, such as computing devices, networking devices, and/or storage devices. A hosted computing environment may also be referred to as a “cloud” computing environment.

The input data discussed herein is data received from a number of originating apparatuses 104A-104N. An originating apparatus 104A may be a personal computing device of an employee on an employer's network, a mobile device connected to a network, a guest device temporarily connected to the network, or any other device which may transmit data through the first network 120 which may need to be obfuscated to maintain privacy or security.

In some examples, the message rewriter 106 receives input information from an originating apparatus 104. The input information transmitted by the originating apparatus 104A may be in a plain text form and may be transmitted within the first network 120 in Hypertext Markup Language (HTML), as JavaScript objects, in plain text, or in an already partially or fully obfuscated form having a structure readable by the message rewriter 106.

In the illustrated example, the message rewriter 106 then transmits the received input information to the tagging module 108. The message rewriter component 106 or tagging module 108 may perform analysis of the input information to generate a data structure wherein a key and a data item are organized into a key-value pair, such as a tuple. In one example, the key is a data field identifier, and the value is a value of the data field. The key may be implied from the input information, such as from a structure of an email address included in the input information. Alternatively, the input information may be received from the originating apparatus 104A as a key and a data item associated with the key, which are then parsed from the input information to identify the key-value pair. Multiple key-value pairs may be generated from or included in the input information. For example, the input information, or event, may include two keys (e.g., “login” and “IP address”) and two corresponding values (e.g., “jjame@example.com” and “1.2.3.4”).

Turning to FIG. 1B, the tagging module 108, in one example, includes a tagging control module 156, an evaluation function module 152, a tag mapping module 154, and an evaluation function store 150. The tagging control module 156 manages the generation of a data tag for the input information within the tagging module 108. Additionally, the tagging control module 156 may perform the action of generating the tuple comprising the key and the data item. The tagging control module 156, in this example, requests an evaluation function from the evaluation function module 152. In some implementations, the tagging control module 156 requests the evaluation function specifically. In alternative implementations, the tagging control module 156 passes the input information to the evaluation function module 152, and the evaluation function module 152 analyzes the input data as a whole, or in part, to determine an appropriate evaluation function to be used to generate the data tag.

In some examples, the evaluation function may optionally be stored in an evaluation function store 150. The evaluation function module 152 in such implementations may request a specific evaluation function from the evaluation function store 150. Alternatively, the evaluation function module 152 may request all stored evaluation functions of the evaluation function store 150 either at once, individually, or in groups, until a correct evaluation function to be applied to the input information is determined.

The evaluation functions available to the evaluation function module 152 may be pre-defined prior to the implementation of the data tag system 100. Alternatively, or additionally, the evaluation function store 150 may contain user-defined functions created by a user of the data tag system 100. In another alternative, the user may request an additional evaluation function be stored in the evaluation function store 150, and a user of the data tag system 100 may then configure and store the additional evaluation function in the evaluation function store 150 so that the additional evaluation function may be accessed and used by the evaluation function module 152. When accessed by the evaluation function module 152, the evaluation function may then be applied to the input information to generate a result. The evaluation function module 152 may use the result to generate a data tag. Alternatively, the tagging control module 156 may receive and use the result to generate a data tag. The data tag may then be associated with the input information by the tag mapping module 154 or the tagging control module 156.

Evaluation functions are used to perform analysis of the input information, or a data item of the input information, to generate a processing result. The processing result of the evaluation function applied to the data item is used to generate a data tag. For example, an evaluation function may be applied to a data item such as an input username (e.g., jjame@example.com) and generate a processing result indicating whether the username is in a defined format accepted by a corporate login system standard (e.g., first initial followed by the first four letters of a last name, then followed by an “@” symbol and the company's email domain address). The processing result indicating the data item, here the input username, is in a defined format may then be used to create a data tag, where the data tag comprises the processing result. Alternatively, additional processing may be applied to the processing result to generate the data tag. For example, the processing result may indicate that the user is indeed John James, while the data tag may indicate that the user is an authorized person. The evaluation function may, alternatively, be used to determine the length of a string of the input information. In another alternative, the evaluation function may be used to determine a method of a login attempt to a system. Alternatively, the evaluation function may be used to determine a version of a network address. Alternatively, the evaluation function may be used to determine a port used to access a system, or that a port number used to access the system is less than a threshold value. Alternatively, the evaluation function may be used to determine the type of originating apparatus transmitting the input information or return a Boolean value representing whether the originating apparatus 104A was logically located within the first network 120. Alternatively, where a plurality of data items, for example a login name and an IP address of the originating apparatus 104A, or a plurality of key-value pairs are determined from the input information, the evaluation function may be applied to the plurality of data items, or to the plurality of key-value pairs, to generate a data tag. Alternatively, where a plurality of data items or a plurality of key-value pairs are determined from the input information, a first evaluation function may be applied to a first data item or a first key-value pair, and a second evaluation function different from the first evaluation function may be applied to a second data item or second key-value pair different from the first data item or the first key-value pair to generate a data tag. Alternatively, a first evaluation function may be applied to a data item or a key-value pair, and a second evaluation function differing from the first evaluation function may be applied to the data item or the key-value pair to generate a data tag. For example, the evaluation function or evaluation functions to be applied could be dependent on one or both keys from multiple key-value pairs from the input information, which are then applied on the corresponding value or values.

Alternatively, the evaluation function may be used to determine whether the formatting of the input information conforms to a defined format. Alternatively, the evaluation function may be used to compare an IP address of the input information to a list of IP addresses to be blocked or allowed and determine whether the originating apparatus 104A should be allowed to access a network resource. Alternatively, the evaluation function may be used to perform error checking on the input information and provide an output indicating whether an error in the input information was detected. For example, if the input information is a file path, the evaluation function may be used to determine whether the file path is valid within the first network 120. Additionally, the evaluation function may be used to return the drive label of the file path (e.g., for C:\users\jjames, an evaluation function may return C:\).

The tag mapping module 154, in one example, is the component of the tagging module 108 which controls the association between the input information and the generated data tag. In some examples, the tag mapping module 154 receives the result of the evaluation function applied to the input information by the evaluation function module 152 or tagging control module 156 and creates a data tag based on the result. In some other implementations, the tagging control module 156 generates a data tag based on the result of the evaluation function applied by the evaluation function module 152 and transmits the input information along with the data tag to the tag mapping module 154. In both examples, the tag mapping module 154 also creates an association between the input information and the data tag. This association may be another piece of data transmitted with the data tag and the input information, defining the link between the input information and the data tag. In another example, the association may be represented by the creation of a single data structure which includes both the input information and the data tag. When the input information and the data tag have been associated by the tag mapping module 154, the data tag, input information, and association information are transmitted back to the tagging control module 156 to be transmitted to the message rewriter 106 for further processing within the data tag generation system 110.

Additionally, the evaluation function module 152, the tag mapping module 154, or another component of the tagging module 108 (e.g., the tagging control module 156) may learn, from the inputs to the tagging module 108 received over a period of time (e.g., a day, a week, a month, etc.), to recognize a normal range of potential input information, and generate an evaluation function to determine whether newly received input information conforms to this normal range. In another example, the evaluated period of time may shift; for example, the evaluation function module 152 may use information from the past ten days to update the evaluation function once per day. Other timeframes and update frequencies may also be used. Alternatively, the evaluation function may be used to determine whether the input information is received within a timeframe during which similar information would be expected to be received. Where desirable, in some examples, only evaluation functions which preserve the privacy of the input information after the input information has been obfuscated may be created and stored within the tagging module 108.

The evaluation function to be applied may be selected, for example, by the tagging control module 156 or the evaluation function module 152. In this example, when an evaluation function has been selected, the evaluation function may be applied by the evaluation function module 152 to the input information, or the data item of the input information where a key and data item tuple has been generated by the evaluation function module 152 or tagging control module 156. The application of the evaluation function by the evaluation function module 152, as noted above, generates a result which is then used by components of the tagging module 108, for example the tag mapping module 154 or tagging control module 156, to generate a data tag. The result may, for example, be a binary output of the evaluation function determining that an IP address of the originating apparatus 104A is within a block of IP addresses assigned to users of the first network 120, a timeframe within which the input information was transmitted by the originating apparatus 104A or received by the tagging module 108, a drive label of the path of the input information (e.g., C:\user returns C:\), or a result of an error check determining whether the input information conforms to an expected format.

The result of the application of the evaluation function is then passed to the tag mapping module 154. The tag mapping module 154 receives the result of the evaluation function applied to the data by the evaluation function module 152 and converts the result into a data tag. The tag mapping module 154 then associates the data tag with the input information and returns the input information with the associated data tag to the tagging control module 156.

The input information and associated data tag may then be transmitted outside the tagging module 108 by the tagging control module 156 so that the input information may be prepared for transmission outside the first network 120, for example by the message rewriter 106. The message rewriter 106 maintains the association between the data tag and the input information and passes either the data tag with the input information or the input information alone to the tokenizer 102. Alternatively, where the input information has been parsed into a key and a data item, the message rewriter 106 may pass only the data item to the tokenizer 102 for further processing while maintaining the association between the data item, the key, and the data tag.

The tokenizer 102 accepts input from the message rewriter 106, for example, the input information or the data item, and converts the input into an obfuscated form. The obfuscation may be performed to protect a user's privacy, to protect sensitive information, or for any other purpose. The tokenizer 102 may communicate with an obfuscation information store 112. The obfuscation information store 112 stores information useful for obfuscating data which may be automatically sent to the tokenizer 102 or requested by the tokenizer 102 specifically. For example, the obfuscation information store 112 may include hashing functions (e.g., SHA-1, SHA-2, SHA-256, SHA-512, MD5, MD6, PMAC, NTLM, LANMAN, CRC-64, BSD checksum, etc.), salt values, public key values, anonymization tables, cryptographic algorithms, or any other data useful for obfuscating, anonymizing, or pseudonymizing information. Different obfuscation information may be applied to separate elements of a single data item, or to different data items of the same or different types, by the tokenizer 102. Alternatively, the obfuscation of the input described herein may be performed by the message rewriter 106. The message rewriter 106 may be in communication with an obfuscation information store 112 directly, or a method to obfuscate the input may be stored within the message rewriter 106.

After the input information has been obfuscated, in whole or in part, the tokenizer 102 transmits the obfuscated input information back to the message rewriter 106, where the association between the obfuscated input information and the data tag are maintained. The obfuscated input information, the data tag, and information indicating the association between the obfuscated input information and the data tag are transmitted by the message rewriter 106 outside the first network 120, the “trusted” network to an outside computing apparatus 134 in the second network 130 via the network 132. The “trusted” network is a network in which the input information is accessible to devices within the “trusted” network, for example because the input information has not yet been obfuscated or because the information required to reverse the obfuscation is available to a device within the “trusted” network. For all networks outside the “trusted” network, the input information has been reformatted such that some portion has been obfuscated and is not recoverable to devices or users outside the “trusted” network. The network 132 may be a private network, public network, the internet, or any other system for communicating data between two networks. The first network 120 and second network 130 may be separate networks in the same physical location. The first network 120 and second network 130 may be the same physical network but logically separated in software, hardware, or a combination of the two.

The outside computing apparatus 134 in the second network 130 then receives the obfuscated information, the data tag, and information associating the data tag with the obfuscated information for further processing. The outside computing apparatus 134 can access the data tag information directly, but may not be able to access some or all of the obfuscated input information.

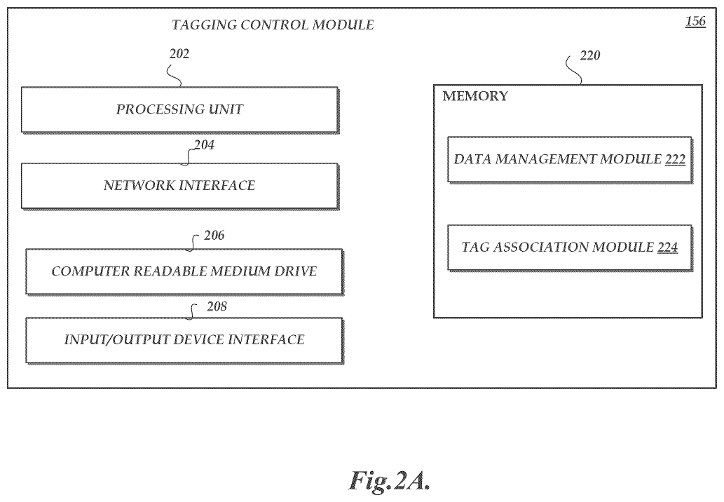

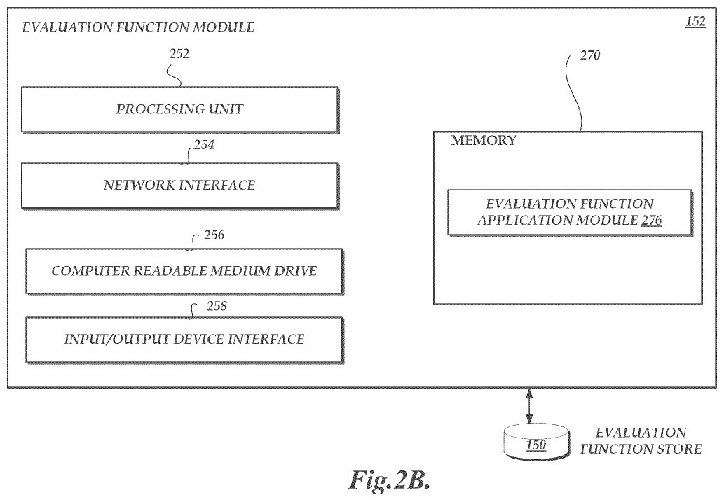

FIG. 2A illustrates various components of an example tagging control module 156 as part of the tagging module 108 of the data tag generation system 110. The tagging control module 156 in this example comprises: a processing unit 202 comprising a processor, such as a physical central processing unit (CPU); a network interface 204, such as a network interface card; a non-transitory computer readable medium drive 206 encoded with instructions executable by the processing unit 202, such as a hard disk drive, solid state drive, flash memory drive, or any other persistent non-transitory computer readable media; an input/output device interface 208; and a computer readable memory 220 including, a data management module 222 and a tag association module 224. The example tagging control module 156 implements various functionality described herein.

The computer readable memory 220 may include computer program instructions that the processing unit 202 executes and data that the processing unit 202 uses in order to implement any of a variety of examples herein. For example, the computer readable memory 220 may store instructions necessary to implement any of the functions of the tagging control module 156 described herein, and in this example, the data management module 222 and the tag association module 224 as shown in FIG. 2A.

An example data management module 222 may manage the transmission of data between the components of the tagging module 108 (e.g., the evaluation function module 152 and the tag mapping module 154). The data management module 222 may perform this function to ensure that received data is associated with a data tag before being sent back to the message rewriter 106. Additionally, the data management module 222 may ensure the data and the data tag are in a format which the message rewriter 106 is capable of receiving and understanding. The data management module 222 may also perform an evaluation of the data received by the tagging module 108, from an originating apparatus 104, to determine whether the evaluation function module 152 or the evaluation function store 150 contains an evaluation function applicable to the received data.

In some examples, the tagging control module 156 may be implemented using any of a variety of computing devices, such as server computing devices, desktop computing devices, personal computing devices, mobile computing devices, mainframe computing devices, midrange computing devices, host computing devices, or some combination thereof.

In some examples, the features and services provided by the tagging control module 156 may be implemented as web services consumable via a communication network. In further examples, the tagging control module 156 is provided by a virtual machine implemented in a hosted computing environment. The hosted computing environment may include a rapidly provisioned and released computing resources, such as computing devices, networking devices, and/or storage devices. A hosted computing environment may also be referred to as a “cloud” computing environment.

FIG. 2B illustrates various components of an example evaluation function module 152 as part of the tagging module 108 of the data tag generation system 110. The evaluation function module 152 in this example comprises: a processing unit 252 comprising a processor, such as a physical central processing unit (CPU); a network interface 254, such as a network interface card; a non-transitory computer readable medium drive 256 encoded with instructions executable by the processing unit 252, such as a hard disk drive, solid state drive, flash memory drive, or any other persistent non-transitory computer readable media; an input/output device interface 258; and a computer readable memory 270, including an evaluation function application module 276. The evaluation function module 152 may also be in communication with an evaluation function store 150 located outside of the evaluation function module 152, physically or logically. Alternatively, the evaluation function store 150 may be stored in the computer readable memory 270 of the evaluation function module 152. The example evaluation function module 152 implements various functionality described herein.

The evaluation function application module 276 may receive an evaluation function from the evaluation function store 150 to be applied to the input information. The evaluation function received from the evaluation function store 150 may be based on a request sent by, for example, the evaluation function application module 276 or another component of the evaluation function module 152 or the tagging module 108. Alternatively, the evaluation function application module 276 may include an evaluation function to be applied to input information received by the evaluation function module 152. Where the evaluation function application module 276 has access to a set of evaluation functions from which less than the entire set is intended to apply to the input information, the evaluation function application module 276 may determine the correct evaluation function to apply. The determination of which evaluation function to apply by the evaluation function application module 276 may be based on, for example, the key where input information is divided into a key and value pair, or some aspect of the input information processed by the evaluation function application module 276.

The evaluation function store 150 may include a variety of evaluation functions applicable to a range of input information types. The evaluation functions may apply to all types of expected input information, or a subset of evaluation functions may be applicable to a corresponding subset of input information types or formats. Evaluation functions within the evaluation function store 150 all maintain the privacy or security of the input information after the input information has been obfuscated, such that an outside computing apparatus 134 cannot use the result of the applied evaluation function, contained in the data tag generated, for example, by the evaluation function module 152 or the tagging control module 156, to recreate information which has been obfuscated.

As discussed, the determination of whether an evaluation function should be contained in the evaluation function store 150 depends on whether the result of the evaluation function, when incorporated in a data tag, would harm the security or privacy of the obfuscated input information transmitted outside the first network 120. In one example of determining whether an evaluation function may be valid for storage in the evaluation function store 150, a user may provide an evaluation function identifying that the device from which input information originated was logically located within the first network 120. This example evaluation function does not allow an outside computing apparatus 134 to determine the precise device from which the input information originated. Therefore, this example evaluation function may be a valid evaluation function to be stored in the evaluation function store 150 when information about the originating network is not considered private or a risk to security. Alternatively, a user may have submitted an evaluation function which returns a result containing the MAC address of the originating apparatus 104A of the input information for inclusion in the evaluation function store 150. This example evaluation function, when incorporated in a data tag by the evaluation function module 152 or tagging control module 156, could allow an outside computing apparatus 134 to determine identifying information about the originating apparatus 104A. Therefore, the evaluation function returning the MAC address of the originating apparatus 104A may not be a valid evaluation function for the data tag generation system 110 where knowing the identity of the originating device would violate the security or privacy of the data being obfuscated.

The determination of whether an evaluation function is appropriate for storage in the evaluation function store 150 may be made automatically, and may be performed by the evaluation function module 152, the tagging control module 156, the evaluation function store 150, an evaluation function application module 276, or any other component of the data tag generation system 110 which receives proposed evaluation functions and is capable of determining whether the evaluation function is valid for use in the data tag generation system 110 (e.g., validating the proposed evaluation function does not allow for de-obfuscation of the data). Evaluation functions may be transmitted to the evaluation function store 150 through the data tag generation system 110 before or during runtime. In this case, the evaluation functions would be evaluated for privacy and security as they are received by the data tag generation system 110, and the evaluation may be conducted by a component therein. Alternatively, the evaluation function store 150 may be maintained separately from the data tag generation system 110. In this case, the evaluation function store 150 or a component connected to the evaluation function store 150 allowing for the addition of evaluation functions may make the determination as to whether the proposed evaluation function is appropriate for use in the data tag generation system 110 and storage in the evaluation function store 150.

The computer readable memory 270 may include computer program instructions that the processing unit 252 executes and data that the processing unit 252 uses in order to implement examples. For example, the computer readable memory 270 may store instructions necessary to implement the evaluation function application module 276. As noted above, the evaluation function application module 276 may assist in the determination as to whether a newly proposed evaluation function violates the security or privacy of the data to be tagged and obfuscated. Additionally, the evaluation function application module 276 may assess the input information received by the tagging module 108 and determine the appropriate evaluation function to request from the evaluation function store 150. The evaluation function application module 276 may then apply the requested evaluation function to the input information to generate a result for use by the tagging control module 156, tag mapping module 154, or another component to create a data tag based on the result generated by the application of an evaluation function to input information. Alternatively, the evaluation function application module 276 may be to both generate a result from the application of an evaluation function and format the result into a data tag, which may be associated with the input information by another component of the tagging module 108.

In some examples, the evaluation function module 152 may be implemented using any of a variety of computing devices, such as server computing devices, desktop computing devices, personal computing devices, mobile computing devices, mainframe computing devices, midrange computing devices, host computing devices, or some combination thereof.

In some examples, the features and services provided by the evaluation function module 152 may be implemented as web services consumable via a communication network or a set of communication networks. In further examples, the evaluation function module 152 is provided by a virtual machine implemented in a hosted computing environment. The hosted computing environment may include a rapidly provisioned and released computing resources, such as computing devices, networking devices, and/or storage devices. A hosted computing environment may also be referred to as a “cloud” computing environment.

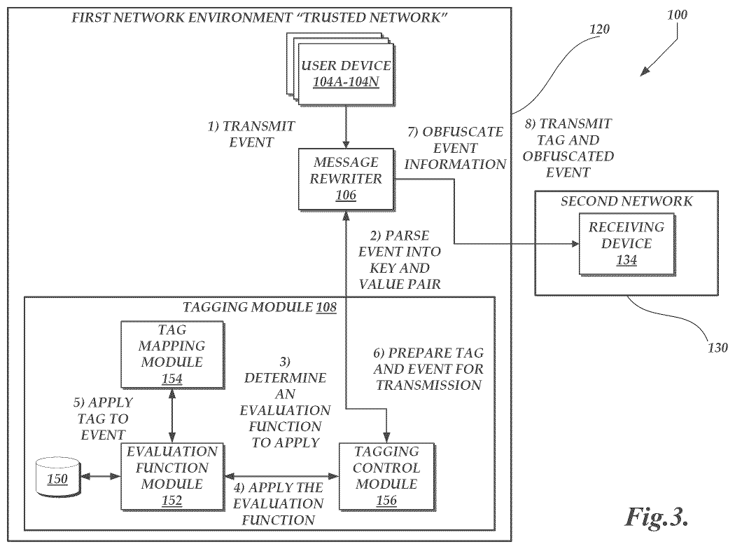

FIG. 3 illustrates an example data flow diagram of the data tag system 100. Beginning at the originating apparatus 104, which may be a user device, an event data is transmitted to the message rewriter 106. The event data may be sent in a plain text, partially obfuscated, or completely obfuscated form. The event may be transmitted in HTML, as a JavaScript object, or in any other form used by the various components of the first network 120. The event may contain information about the occurrence of a login attempt (e.g., the time of the login attempt, the login credentials, the identity of the device attempting a login, the network address of the originating apparatus 104, etc.), the use of a network application of the first network 120 (e.g., opening of a connection between two different user devices 104A and 104B of the first network 120), a system log having a key and a value, or any other information which may be transmitted both inside the first network 120 and outside the first network 120 to an outside computing apparatus 134 which may be logically located in a second network 130.

The event may additionally include secondary information about the data being transmitted within the first network 120. For example, the event may include username information, a time, an IP address, or device information related to the transmitting device (e.g., the originating apparatus 104) and associated with an attempt to send a message to a second originating apparatus, such as an originating apparatus 104B within the first network or an outside computing apparatus 134 outside the first network 120.

The event is received by the message rewriter 106 where the event may be parsed into a key and a value associated with the key. The key may be a unique identifier of the event, such that the event may be stored in a database or other data repository structure (e.g., a data lake, a table, etc.), and recovered individually based on the key. The key may be generated based on some, or all, of the event information. Alternatively, the key may be a randomly generated value assigned to the event. The value may be some or all of the information associated with the event. The value may be data items which individually or in combination may be used to reconstruct some or all of the information of the event.

The event may be received by the message rewriter 106 in plain text, partially obfuscated, or completely obfuscated, as described previously. Where the event is received by the message rewriter 106 in a format other than plain text, the message rewriter 106 may fully or partially de-obfuscate the event information such that the event may be processed by other components of the data tag generation system 110 within the first network 120, or so that a key and a value associated with the key may be generated by the message rewriter 106. The key and the value are combined into a pair, or tuple, before being transmitted by the message rewriter 106 to the tagging module 108.

Once transmitted to the tagging module 108, the key and value may be received by the tagging control module 156. Within the tagging module 108, a determination is made as to which evaluation function to apply to the value. The determination of which evaluation function to apply may be based on the key of the key-value pair, information associated with the event (e.g., an identifier of the originating apparatus 104), some or all of the information to be used by the tagging module 108 to generate the tag, or any other information received by the tagging module 108 from the message rewriter 106.

The determination of which evaluation function to apply may be made by the tagging control module 156. Alternatively, the determination may be made by the evaluation function module 152. The evaluation function module 152 may be in communication with an evaluation function store 150 as part of the tagging module 108. The evaluation function may be selected from a plurality of pre-defined functions. The plurality of pre-defined functions may be stored in the evaluation function store 150. The evaluation function module 152 may use information from the evaluation function store 150 (e.g., data inputs for the stored evaluation functions, secondary information about the evaluation functions contained in the evaluation function store 150, etc.) to determine the evaluation function to be applied to the event information. Where the event comprises a system log, the evaluation function module 152 may use a key of the system log to determine the evaluation function to be applied to the event information.

The evaluation function is then applied by the evaluation function module 152. The application of the evaluation function returns a result based on the evaluation function used. The result may be a single information item related to some or all of the information of the event, the value of the key-value pair, or the key and value of the key-value pair. The result may alternatively be more than one information item, each result related to the same or different information of the event. The result of the evaluation function may be used by the evaluation function module 152, and in some implementations the tagging control module 156, to determine a data tag for the event.

When the evaluation function has completed, and information necessary for a data tag is generated, the information related to the event (e.g., the event information or the key-value pair), and the result of the evaluation function are transmitted to the tag mapping module 154 where the data tag is coupled to the event. The coupling of the data tag to the event may be adding the data tag as a separate value associated with the key of the key-value pair, appending the data tag to an existing value of the key-value pair, associating the data tag with an identifier of the event, appending the data tag to the event information, or any other method of connecting the data tag to the event information such that a receiving element or device may understand that there is an association between the data tag and the event.

When the data tag has been coupled to the event by the tag mapping module 154, the tagging control module 156 may prepare the tag and event for transmission outside the first network 120, where the event will no longer be available for processing. The preparation for transmission may involve storing the event information and the data tag in a data structure used by the first network 120 for communication (e.g., as a JSON object), adding additional information to maintain the association between the event information and the data tag, or compiling a set of data tags to be transmitted with the event, where the set of data tags are each associated with the event and may be related to the same or different information of the event.

The prepared data tag and event are transmitted from the tagging module 108, possibly by the tagging control module 156, to the message rewriter 106. At the message rewriter 106, the event information is obfuscated for transmission outside the first network 120. The message rewriter 106 may obfuscate some, or all, of the contents of the event information such that an outside computing apparatus 134 located within a second network 130 may not access the obfuscated event information. The obfuscation may include anonymizing the data. For example, by removing identifying information (e.g., a username, a device identifier, an age of the user, other personal information of the user, or other information which may be usable to identify either the user or device individually or as part of a group), by encrypting information, or by separating identifying information from the event such that the identifying information may no longer be associated with the event. The event information may be obfuscated in other ways, for example, as discussed above.

The data tag may or may not be obfuscated by the message rewriter 106, for example to secure the data tag during transmission over an open network. Where the data tag is obfuscated, the data tag is still readable and interpretable by an outside computing apparatus 134 located within a second network 130.

Finally, in this example implementation of the data tag system 100, the data tag and the obfuscated event are transmitted outside of the first network 120 to an outside computing apparatus 134 of a second network 130. The transmission may be performed by the message rewriter 106, by the network interface 254 of the data tag generation system 110, or by any other component of the data tag generation system 110 to communicate outside the first network 120.

The outside computing apparatus 134 may be able to decode a portion of the event information, for example the key, but is not able to access private information of the event information which has been obfuscated to protect a user's privacy or security. The outside computing apparatus 134 may need to decode or decrypt the data tag where the data tag is obfuscated, for example to block interception of the data tag and event by a third party (not shown). The outside computing apparatus 134 may then perform analysis on the data tag within the second network 130 or within any other network while maintaining the privacy or security of the user or device generating the event information (e.g., originating apparatus 104).

The further analysis of the event information by the outside computing apparatus 134 may include determining whether the data tag indicates that the event information matches some criteria set out in the evaluation function, examples of which have been described previously herein. For example, the outside computing apparatus 134 may be a login provider or an element of a login provider accepting user information from users located within the first network 120. When the outside computing apparatus 134 receives login information, in the form of event information, for a user of the originating apparatus 104, a data tag may be appended to the login information by the tagging module 108 indicating whether the username conforms to a standard username configuration of the login system. Where the data tag indicates that the username conforms to the standard, the event information may be transmitted to another element, which may be a secure element, of the second network 130 where the username and password are processed to allow the user of the originating apparatus 104A to login to the system. Where the data tag indicates that the username does not conform to the standard, the login information may be discarded by the outside computing apparatus 134 and no further processing is performed on the login information, saving computing and network resources which would otherwise be wasted attempting to process invalid login credentials.

In another example, the event information may indicate an IP address of the originating apparatus 104. The tagging module 108 may then indicate, based on the result of the evaluation function, whether the IP address is within a secure block of IP addresses allowed to access the system of the outside computing apparatus 134. Where the data tag indicates that the IP address is within the secure block, the user may be allowed access to the system of the outside computing apparatus 134 based on the event information. Where the data tag indicates the IP address is not within the secure block, the outside computing apparatus 134 may deny access to the originating apparatus 104A and decline to accept any further transmission originating from the originating apparatus 104A to maintain security of the second network 130.

In another example, the evaluation function used by the tagging module 108 to apply the evaluation function may have been a user-defined function provided to the data tag generation system 110 by the outside computing apparatus 134. For example, the outside computing apparatus 134 may want to restrict access to the second network 130 to users who request access within a certain timeframe. Here, the outside computing apparatus 134 would provide the user-defined function returning a true or false value based on the timestamp of the event transmitted by the originating apparatus 104, and the user-defined function may be stored by the tagging module 108 in the evaluation function store 150. Here, when the outside computing apparatus 134 receives an event, the outside computing apparatus 134 knows to expect a data tag indicating whether the event was transmitted at a time during which access to the second network 130 would be allowed. The outside computing apparatus 134 can then determine based on the tag whether to allow network access to the originating apparatus 104A which transmitted the event. In the case that the tag indicates the time is outside of the allowed access time for the second network 130, the outside computing apparatus 134 can decline to accept any further transmissions from that source to protect the security of the second network 130.

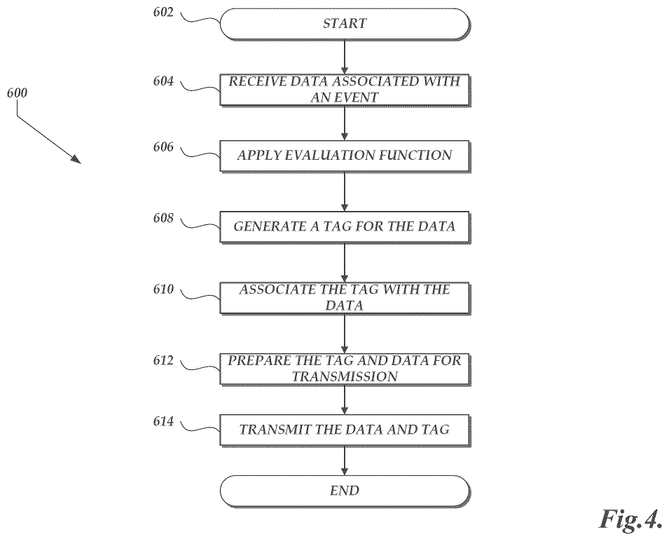

FIG. 4 is a flow diagram of an example routine or method 600 implemented by the data tag generation system 110 for generating a data tag and managing the association between a data tag and event information. As described herein, the data tag generation system 110 may include a tagging module 108 comprising a tagging control module 156, tag mapping module 154, evaluation function module 152 and an evaluation function store 150. In some examples, the message rewriter 106, tokenizer 102, and obfuscation information store 112 may implement all or some portions of the routine 600.

At block 602, the routine 600 starts. The routine 600 may begin in response to the generation of data for an event by an originating apparatus 104. For example, an attempt by the originating apparatus 104A to make a connection to a second network 130 for the purpose of communicating data between the first network 120 where the originating apparatus 104A is located and an outside computing apparatus 134 located within the second network 130.

After starting, the routine 600 moves to block 604 and data associated with an event is received by the data tag generation system 110. The data may be received by the message rewriter 106. Alternatively, the data may be received directly by the tagging module 108.

The routine 600 then moves to block 606, where the evaluation function is applied to the data associated with an event received at block 604. The evaluation function may be a user-defined function. The evaluation function may be stored in an evaluation function store 150. Alternatively, the evaluation function may be stored in the evaluation function module 152. Alternatively, the evaluation function may be stored elsewhere in the computer readable memory 220 of the tagging module 108. Alternatively, the evaluation function may be stored within another component logically located within the first network 120 which is in communication with the tagging module 108.

Applying the evaluation function may comprise determining whether the data meets a requirement. Alternatively, applying the evaluation function may comprise determining whether the data is outside a threshold value. Alternatively, applying the evaluation function may comprise performing a calculation using the data.

When the evaluation function has been applied to the data, the routine 600 moves to block 608. At block 608, a data tag is generated for the data based on the result of the evaluation function being applied to the data. The generation of the data tag may comprise storing the result of the evaluation function in a data structure. Alternatively, the generation of the data tag may comprise further manipulation of the result of the evaluation function. The data tag may be generated by the tagging control module 156. Alternatively, the data tag may be generated by the evaluation function module 152.

When a data tag has been generated, the routine 600 moves to block 610. At block 610, the generated data tag is associated with the data from which the data tag was generated. The association allows for an outside computing apparatus 134 to know that the data tag contains information related to the event after the data associated with the event has been obfuscated. The data tag may be associated with some, or all, of the data associated with the event. Associating the data tag with the event may comprise storing the data and the data tag within a same data structure (e.g., a JSON object). Alternatively, associating the data tag with the data may comprise describing a link (e.g., in a linked list) between the data tag and the event which is interpretable by an outside computing apparatus 134 after the data has been obfuscated.

After the data tag has been associated with the data, the routine 600 moves to block 612. At block 612, the data tag and the data are prepared for transmission. Preparing the data tag and the data for transmission may comprise obfuscating the data such that private or secret information included in the data is not readable by an outside computing apparatus 134. As discussed previously herein, obfuscating the data may comprise encrypting some or all of the data, removing portions of the data which would violate the privacy of a user of the originating apparatus 104, or any other technique which preserves the privacy or security of the data associated with the event.

The preparation of the data tag and the data for transmission may occur at the tagging control module 156. Alternatively, the preparation may occur at the tag mapping module 154. Alternatively, another component of the tagging module 108 may prepare the data and the data tag for transmission. Alternatively, the message rewriter 106 may perform the preparation. Alternatively, the data and the data tag may be prepared by the tokenizer 102. When the data and the data tag are prepared for transmission, the routine 600 then may move to block 614. Alternatively, where the data and tag are not to be transmitted immediately, the routine 600 moves to block 616 and ends. In one example, the data and the data tag may not be transmitted because the data tag generation system 110 is creating a batch, or group, of data and data tags to be transmitted together.

At block 614, the data and the data tag may be transmitted. The transmission may be made to an outside computing apparatus 134 located within a second network 130. The transmission may alternatively be made to an edge device of the second network 130 for analysis or forwarding to another device either within the second network 130 or within a third network. The transmission may be performed by the message rewriter 106. Alternatively, the network interface 254 of the data tag generation system 110 may transmit the data and the data tag. When the transmission has been completed, the routine 600 moves to block 616 and ends.

All of the methods and tasks described herein may be performed and fully automated by a computer system, such as the data tag system 100. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes machine-readable instructions or modules stored in a memory or other non-transitory computer-readable storage medium or device (e.g., solid state storage devices, disk drives, etc.). The various functions disclosed herein may be embodied in such machine-readable instructions or may be implemented in application-specific circuitry (e.g., an application specific integrated circuit (ASIC) or a field programmable gate array (FPGA)) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some examples, the computer system may be a cloud-based computing system whose processing resources are shared by multiple distinct business entities or other users.

Many other variations than those described herein are apparent from this disclosure. For example, depending on the example, certain operations, events, or functions of any of the processes or routines described herein can be performed in a different sequence, can be added, merged, or left out altogether (e.g., not all described operations or events are necessary for the practice of the routine). Moreover, in certain examples, operations, events, or functions can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The elements of a method, process, routine, or function described in connection with the examples disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or blocks. Thus, such conditional language is not generally intended to imply that features, elements and/or blocks are in any way required for any examples or that any example necessarily include logic for deciding, with or without other input or prompting, whether these features, elements and/or blocks are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “an” should generally be interpreted to include one or more described items. Accordingly, phrases such as “a device to” are intended to include one or more recited devices. Such one or more recited devices can also collectively carry out the stated recitations. For example, “a processor to carry out recitations A, B and C” can include a first processor to carry out recitation A working in conjunction with a second processor to carry out recitations B and C.

What is claimed is:

1. A non-transitory machine-readable storage medium encoded with instructions executable by a processor of a computing device, the machine-readable storage medium comprising instructions to:
receive, at the computing device, data associated with an event from an originating apparatus, wherein the data comprises a key and a data item associated with the key, and wherein the data item is accessible for processing in a network environment;
apply, at the computing device, an evaluation function to the data item, wherein applying the evaluation function generates a processing result characterizing an aspect of the data item;
generate, at the computing device, a tag based on the processing result;
associate, at the computing device, the tag with the data, wherein the tag is transmitted with the data outside the network environment where the data item is not accessible for processing outside the network environment; and
provide, at the computing device, the tag for transmission.

2. The non-transitory machine-readable storage medium of claim 1, further comprising instructions to provide, at the computing device, the data for transmission.

3. The non-transitory machine-readable storage medium of claim 1, further comprising instructions to transmit the tag to a device of a second network environment.

4. The non-transitory machine-readable storage medium of claim 1, further comprising instructions to transmit the data and the tag to a message rewriter, wherein the message rewriter obfuscates the data, and wherein the tag is associated with the obfuscated data.

5. The non-transitory machine-readable storage medium of claim 1, further comprising instructions to receive, at the computing device, an evaluation function.

6. The non-transitory machine-readable storage medium of claim 1, further comprising instructions to organize, at the computing device, the key and the data item into a key-value pair.

7. The non-transitory machine-readable storage medium of claim 1, wherein the processing result indicates the data item is in a defined format, and wherein the tag comprises the processing result.

8. A non-transitory machine-readable storage medium encoded with instructions executable by a processor, the machine-readable storage medium comprising instructions to:
receive, at a computing device having a processor and a memory executing in a network environment, data associated with an event from an originating apparatus, wherein the data is accessible for processing in a network environment;
parse, at the computing device, the data associated with the event to generate a tuple, wherein the tuple comprises a key and a data item paired with the key;
apply, at the computing device, an evaluation function to the data item to generate a data tag;
associate, at the computing device, the data tag with the tuple to create a return data item; wherein the data item in the return data item is not accessible for processing outside the network environment; and
transmit, at the computing device, the return data item for transmission outside the network environment.

9. The non-transitory machine-readable storage medium of claim 8, further comprising instructions to select the evaluation function based on the key.

10. The non-transitory machine-readable storage medium of claim 8, wherein the tuple comprises a key and a plurality of data items.

11. The non-transitory machine-readable storage medium of claim 10, further comprising instructions to apply the evaluation function to the plurality of data items to generate the data tag.

12. The non-transitory machine-readable storage medium of claim 8, wherein the tuple comprises a key and a plurality of data items; and further comprising instructions to apply a second evaluation function, which is different from the evaluation function, to a second data item which is different from the data item to generate the data tag.

13. The non-transitory machine-readable storage medium of claim 8, further comprising instructions to receive, at the computing device, an evaluation function.

14. The non-transitory machine-readable storage medium of claim 8, further comprising instructions to:
transmit, at the computing device, the return data item to a message rewriter of the computing device; and
obfuscate, at the computing device, the tuple of the return data item.

15. A non-transitory machine-readable storage medium encoded with instructions executable by a processor, the machine-readable storage medium comprising instructions to:
receive, at a computing device having a processor and a memory executing in a network environment, a system log from an originating apparatus, wherein the system log comprises a key and a value, and wherein the value is accessible for processing in the network environment;
determine, at the computing device, a user-defined function to be applied to the value, wherein the user-defined function corresponds to the key in the system log;
apply the user-defined function to the value, wherein applying the user-defined function comprises generating a data tag characterizing the value;
couple the data tag to the system log, wherein the data tag is transmitted with the system log outside the network environment, and wherein the value is not accessible for processing outside the network environment; and
transmit the data tag for transmission outside the network environment.

16. The non-transitory machine-readable storage medium of claim 15, further comprising instructions to obfuscate the value.

17. The non-transitory machine-readable storage medium of claim 15, further comprising instructions to obfuscate the system log.

18. The non-transitory machine-readable storage medium of claim 15, further comprising instructions to transmit the data tag separately from the system log outside the network environment, wherein an association between the data tag and the system log is maintained.

19. The non-transitory machine-readable storage medium of claim 15, further comprising instructions to receive, at the computing device, a user-defined function.

20. The non-transitory machine-readable storage medium of claim 15, wherein the instructions to determine a user-defined function to be applied to a portion of the value further comprise instructions to validate the user-defined function.
